(19) United States
(12) Patent Application Publication
(10) Pub. No.: US 2008/0198516 A1
(43) Pub. Date: Aug. 21, 2008

(54) Electrostatic discharge (ESD) protection device and method therefor

(75) Inventors: Hui-Chia Fang, Hsinchu (TW); Hung-Chi Chi, Hsinchu (TW); Yuh-Ren Shen, Hsinchu (TW)

Correspondence Address: BACON & THOMAS, PLLC, 625 SLATERS LANE, FOURTH FLOOR, ALEXANDRIA, VA, 22314, US

(73) Assignee: VastView Technology Inc., Hsinchu (TW)

(21) Appl. No.: 11/706,232

(22) Filed: Feb. 15, 2007

(51) Int. Cl. H02H 9/04

(52) U.S. Cl. 361/56

(57) ABSTRACT

A method and device for providing electrostatic discharge (ESD) protection are disclosed. The method uses the gate-controlled conductivity of field n-channel metal-oxide-semiconductor field effect transistor (field NMOSFET), wherein considerable ESD current can be conducted away when any ESD event beyond range of operation voltage, unlike PMOS ESD protection which is to be turned on at negative voltage. Instead of the traditional two-stage ESD protection (using one ESD protection between open drain output and V_{SS} and the other ESD protection between V_{DD} and V_{SS}), the device can be directly used between open drain output and power source V_{DD} for the wide range of operation voltage. Unlike the floating-gate field NMOS using punch through current for ESD protection, a controllable triggered voltage by changing the gate threshold voltage supports the device to be a robust ESD protection.

### BACKGROUND OF THE INVENTION

1. Field of the Invention

The present invention relates to a technology for electrostatic discharge (ESD) protection in semiconductor industry, and more particular for ESD protection method and device between port with open drain output and power source V_{DD}.

2. Description of the Prior Art

In a recent field of fabrication process of semiconductor industry, ESD threats always exist in semiconductor integrated circuits (IC) during wafer fabrication, wafer package, chip equipment, and event after-sale operation. The semiconductor integrated circuit devices become sensitive to damages caused by electrostatic discharges. For example, the possibility ESD threats include human body model (HBM), machine model (MM), charge-device model (CDM) and field-induced model (FIM), demonstrate the damage power of a single ESD event. Hundreds and event thousands times electrostatic voltage of normal operation will be discharged at touching moment then destroys an unprotected internal circuit. As shown in FIG. 1A, an ESD protection therefore has to be placed between any two ports of an internal circuit 110 to prevent a discharge current passing through the internal circuit at ESD event happening. In an exemplary embodiment, an internal circuit 110 has three ports, for major power voltage V_{DD}, for low voltage V_{SS} (V_{SS} is lower than V_{DD} and usually connected to ground), and for input/output (I/O). As ESD event happening, discharge current will flow from high voltage port to low voltage port through the internal circuit 110 and burn the internal circuit, if there is no ESD protection between high voltage port and low voltage port. To protect internal circuit from ESD threat is to set short circuits 120, 130 between ports and low voltage port V_{SS} (ground usually). The short circuit should not function until port voltage is beyond normal operation voltage, and conduct ESD current away as ESD event happening,

Traditionally, a short circuit to conduct current only on high electrostatic voltage can use a diode or a PNP junction with its reverse bias property which will generate punch through current for ESD shunt as reverse bias larger than punch through voltage; or use a p-channel metal-oxide-semiconductor field effect transistor (PMOS) 241 to be a shunt switch turned on by negative gate-voltage whose gate connected to the power voltage V_{DD} (please see FIG. 1B).

An ESD protection 140 such as diode string and floating-gate field n-channel metal-oxide-semiconductor field effect transistor (floating-gate field NMOS) 242 can use punch through current to shunt ESD current (please see FIG. 1C), nevertheless, the punch through voltage can not be controlled precisely. Because impurity ratio and abruptness of PN junction are varied in every producing, the punch through voltage of diode string and floating-gate field NMOS is varied too. A controllable punch through voltage is very important in order to ensure the internal circuit can be operated normally in known condition. For PMOS 241, ESD protection can be triggered by a known trigger voltage, a negative gate-voltage. However, also because of the negative trigger voltage, the PMOS ESD protection is used only between I/O port with normal operation voltage less than power voltage V_{DD} and V_{DD}.

### SUMMARY OF THE INVENTION

The invention provides, in a first aspect, a new ESD protection method and device for solving the traditional problems: the restriction of normal I/O operation voltage less power voltage V_{DD} and an uncontrollable punch through voltage.

In a second aspect, the invention provides a new ESD protection method and device especially for pin with open drain output in semiconductor element.

In order to achieve the aforementioned objects, an ESD device according to the invention includes pin with open drain output combined with a proper pull-up resistor which can be attached to different voltage elements, such as a higher I/O voltage than power voltage V_{DD}.

An ESD protection method according to the invention can shunt ESD current for internal circuit through an n channel of inversion layer below gate field oxide layer of a field n-channel metal-oxide-semiconductor field effect transistor (field NMOS). The n channel can be generated in a depletion layer by a positive ESD voltage on the gate while ESD event happening.

An embodiment according to the invention is one-directional ESD protection device shunting one-directional ESD current for internal circuit by short of a field NMOS while ESD event happening.

Another embodiment according to the invention is two-directional ESD protection device shunting two-directional ESD current for internal circuit by short of one of field NMOSs while ESD event happening.

Other objects, advantages and novel features of this invention will be obvious with the following detailed description when taken in conjunction with the accompanying drawings.

### BRIEF DESCRIPTION OF THE DRAWINGS

FIG. 1A illustrates a prior art to show the relation between traditional ESD protection circuits and internal circuit.

FIG. 1B illustrates a prior art to show the relation between traditional PMOS ESD protection circuit and internal circuit.

FIG. 1C illustrates a prior art to show the relation between traditional floating-gate field NMOS ESD protection circuit and internal circuit.

FIG. 2A shows a schematic diagram of n channel formation below field oxide layer in a field NMOS according to the invention.

FIG. 2B is a schematic diagram to show the relation between poly-gate field NMOS ESD protection device and internal circuit according to the invention.

FIG. 3A is a schematic diagram to show the relation between one-directional ESD protection device and internal circuit according to the invention.

FIG. 3B is a schematic diagram to show the relation between two-directional ESD protection device and internal circuit according to the invention.

FIG. 4A is a top-view layout structure in one embodiment of the one-directional ESD protection device according to the invention.

FIG. 4B is a schematic diagram for the cross-section along a-a line on FIG. 4A.

FIG. 4C is a schematic diagram for the cross-section along b-b line on FIG. 4A.

FIG. 5A is a top-view layout structure in one embodiment of the two-directional ESD protection device according to the invention.

FIG. 5B is a schematic diagram for the cross-section along c-c line on FIG. 5A.

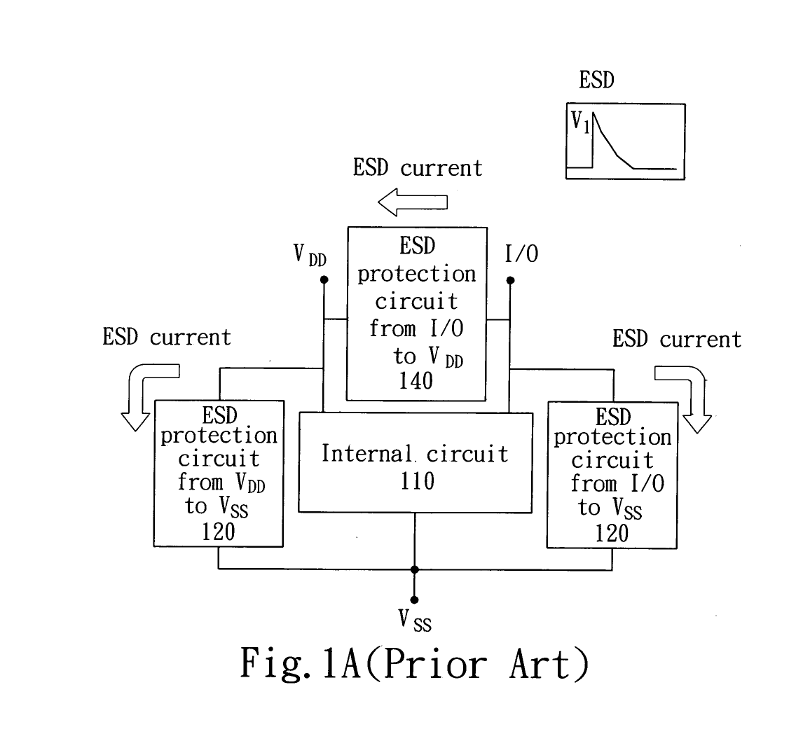

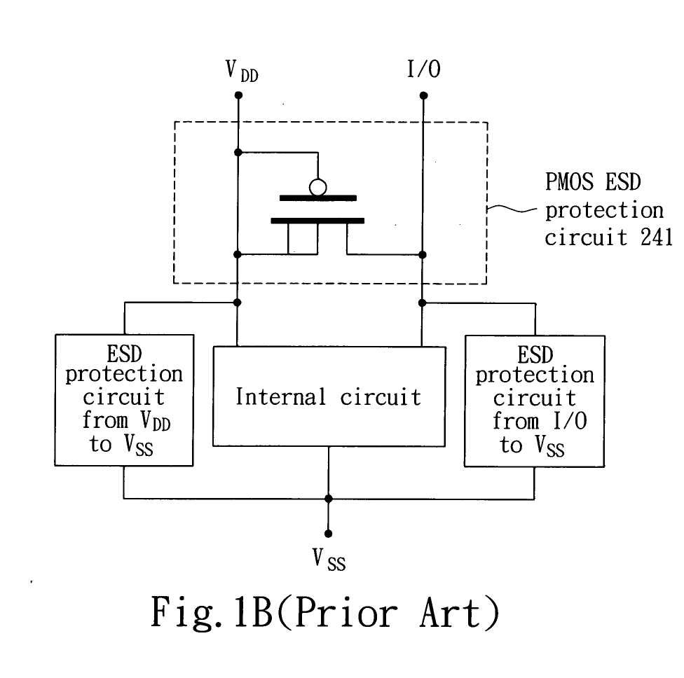

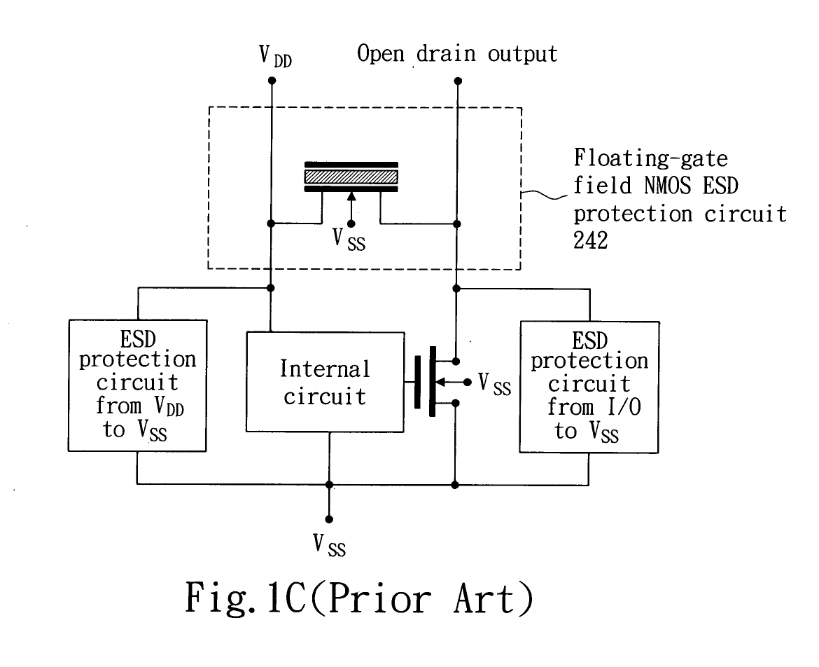

### DETAILED DESCRIPTION OF THE PREFERRED EMBODIMENTS

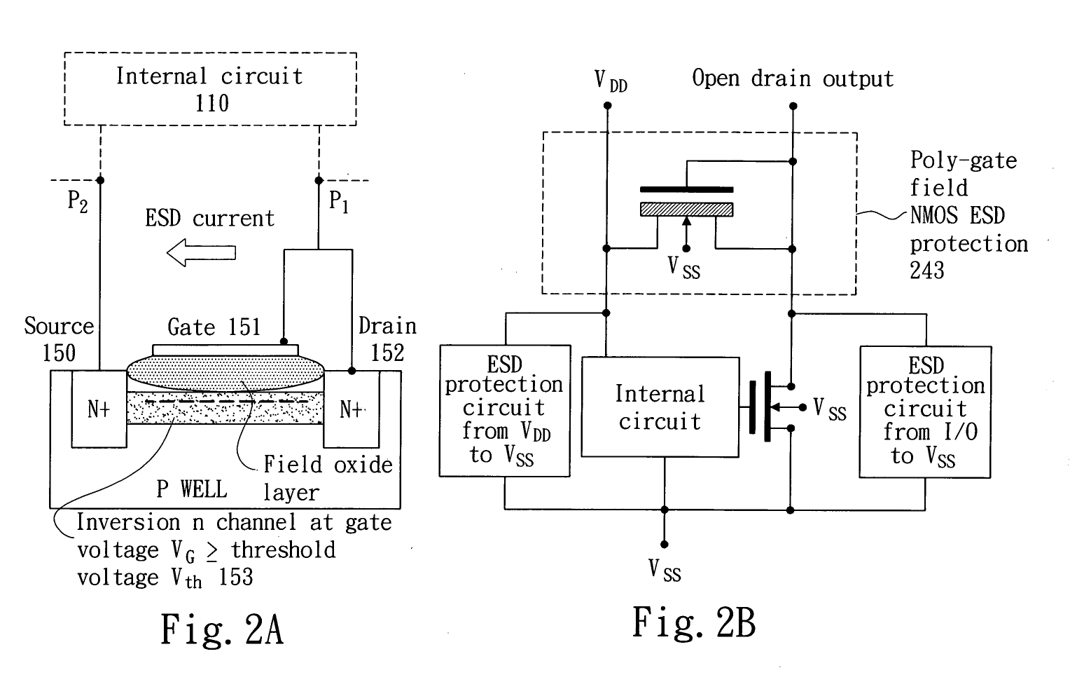

An ESD protection method embodiment according to the invention as shown on FIG. 2A protects an internal circuit 110 against ESD effects and harms. The ESD protection method comprises the following steps: (a) accept ESD current through a first ESD port P₁ while an ESD event happens on the internal circuit; (b) discharge the ESD current from a second ESD port P₂ while an ESD event happens on the internal circuit; and, at the same time, (c) utilize voltage differential between the first ESD port P₁ and the second ESD port P₂ to induce an inversion layer in depletion layer below gate field oxide layer of a 1^{st} NMOS 151 and shunt the ESD current through the inversion n channel 153 from the first ESD port P₁ to the second ESD port P₂ rapidly.

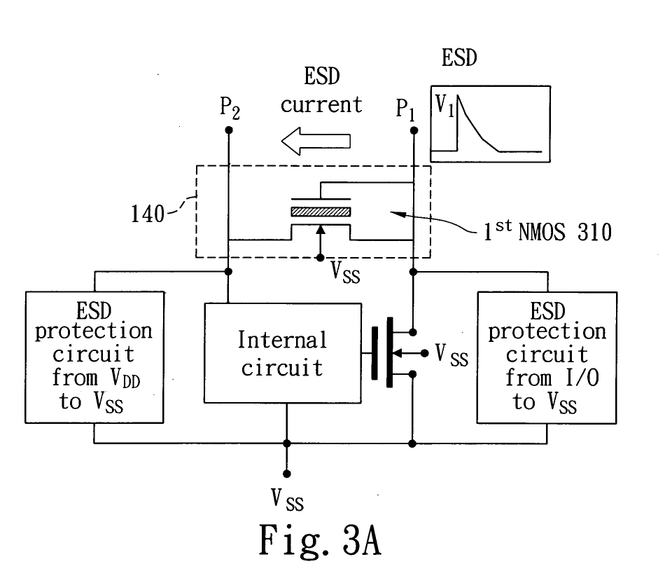

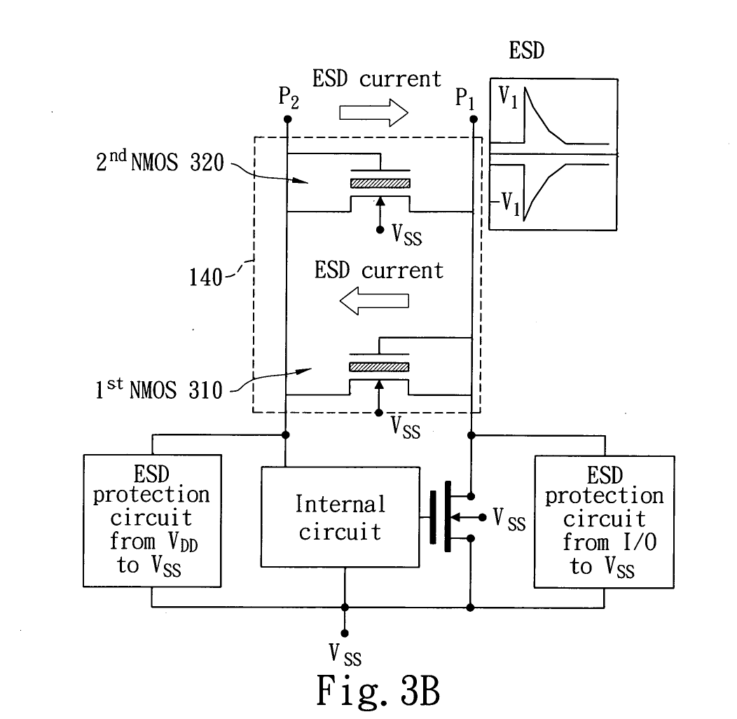

An embodiment of one-directional ESD protection device according to the invention as shown on FIG. 3A protects an internal circuit 110 against ESD effects and harms in one direction. The one-directional ESD protection device comprises: (a) a first ESD port P₁ with voltage V₁ for ESD current acceptance while an ESD event happens on the internal circuit; (b) a second ESD port P₂ with voltage V₂ for ESD current discharge while an ESD event happens on the internal circuit; and (c) a 1^{st} NMOS 310 with its gate connected to the first ESD port P₁, its drain connected to the first ESD port P₁, and its source connected to the second ESD port P₂, wherein a short between its drain and source is formed to shunt ESD current without passing through the internal circuit while voltage differential between the first ESD port P₁ and the second ESD port P₂ is larger and equal than its gate threshold voltage Vₜₕ (V₁−V₂≧Vₜₕ). In normal operation, voltage differential between the first ESD port P₁ and the second ESD port P₂ is smaller than gate threshold voltage Vₜₕ (V₁−V₂<Vₜₕ) and is small enough to not form a short between drain and source on the 1^{st} NMOS. Furthermore, the 1^{st} NMOS is operable to be a field n-channel metal-oxide-semiconductor field effect transistor (field NMOS) with a field oxide layer below gate for increasing threshold voltage Vₜₕ. By choosing the filed NMOS from different semiconductor process, the threshold voltage Vₜₕ can be adjusted to fit different operation voltage condition (V₁−V₂<Vₜₕ). In an exemplary embodiment, a field NMOS with larger Vₜₕ can be used between I/O port with open drain output 440 and power voltage V_{DD} directly as ESD protection. Additionally, an operable poly-gate 410 design on gate of the 1^{st} NMOS provides the better ESD protection result.

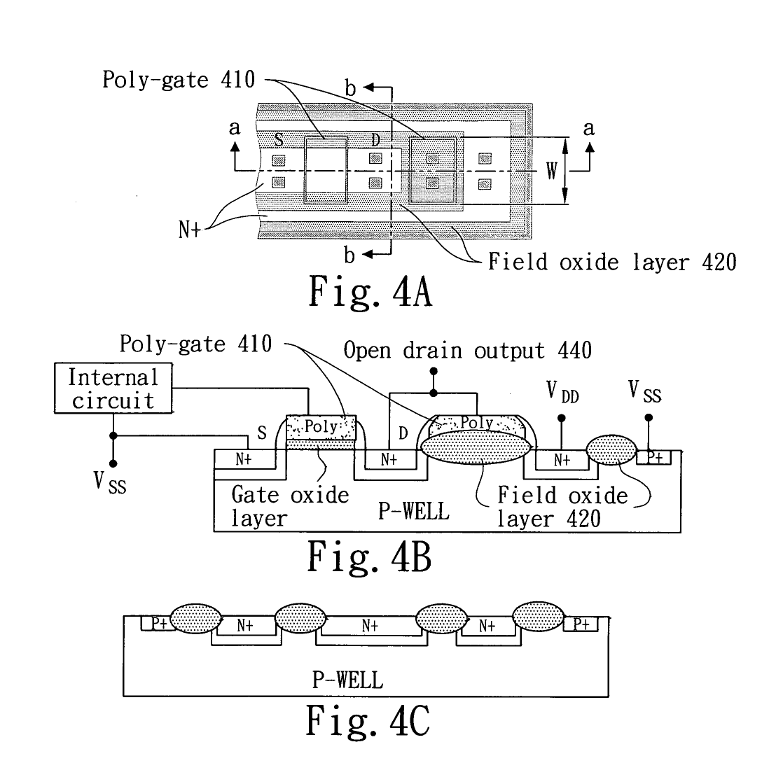

FIG. 4A is a layout structure for the one-directional ESD protection device. The cross-section structure along a-a line and b-b line on FIG. 4A are shown on FIG. 4B and FIG. 4C. Increasing/decreasing the width (W) of poly-gate grown on field oxide layer according to the layout on FIG. 4A is also to increase/decrease the loading of ESD current in n channel below the poly gate for fitting different requirements of ESD protection.

An embodiment of two-directional ESD protection device according to the invention as shown on FIG. 3B protects an internal circuit against ESD effects and harms in both directions. The two-directional ESD protection device comprises: (a) a first ESD port P₁ with voltage V₁ for ESD current acceptance/discharge while an ESD event happens on the internal circuit; (b) a second ESD port P₂ with voltage V₂ for ESD current discharge/acceptance while an ESD event happens on the internal circuit; (c) a 1^{st} NMOS 310 with its gate connected to the first ESD port P₁, its drain connected to the first ESD port P₁, and its source connected to the second ESD port P₂, wherein a short between its drain and source is formed to shunt ESD current without passing through the internal circuit while voltage differential between the first ESD port P₁ and the second ESD port P₂ is larger and equal than its gate threshold voltage Vₜₕ (V₁−V₂≧Vₜₕ); and (d) a 2^{nd} NMOS 320 with its gate connected to the second ESD port P₂, its drain connected to the second ESD port P₂, and its source connected to the first ESD port P₁, wherein a short between its drain and source is formed to shunt ESD current without passing through the internal circuit while voltage differential between the second ESD port P₂ and the first ESD port P₁ is larger and equal than its gate threshold voltage Vₜₕ (V₂−V₁≧Vₜₕ). In normal operation, the absolute value of voltage differential between the first ESD port P₁ and the second ESD port P₂ is smaller than gate threshold voltage Vₜₕ (|V₁−V₂|<Vₜₕ) and is small enough to not form a short between drain and source on either of the 1^{st} NMOS and the 2^{nd} NMOS. Furthermore, the 1^{st} NMOS is operable to be a field n-channel metal-oxide-semiconductor field effect transistor (field NMOS) with a field oxide layer below gate for increasing threshold voltage Vₜₕ. By choosing the filed NMOS from different semiconductor process, the threshold voltage Vₜₕ can be adjusted to fit different operation voltage condition (V₁−V₂<Vₜₕ). In an exemplary embodiment, the 1^{st} NMOS with a field NMOS having larger Vₜₕ can be used between I/O port with open drain output and power voltage V_{DD} directly as ESD protection. Additionally, an operable poly-gate design on gate of the 1^{st} NMOS provides the better ESD protection result. Furthermore, the 2^{nd} NMOS is operable to be a field n-channel metal-oxide-semiconductor field effect transistor (field NMOS) with a field oxide layer below gate for increasing threshold voltage Vₜₕ. By choosing the filed NMOS from different semiconductor process, the threshold voltage Vₜₕ can be adjusted to fit different operation voltage condition (V₂−V₁<Vₜₕ). In an exemplary embodiment, the 2^{nd} NMOS with a field NMOS having larger Vₜₕ can be used as ESD protection to against ESD event from power voltage V_{DD}. Additionally, an operable poly-gate design on gate of the 2^{nd} NMOS provides the better ESD protection result.

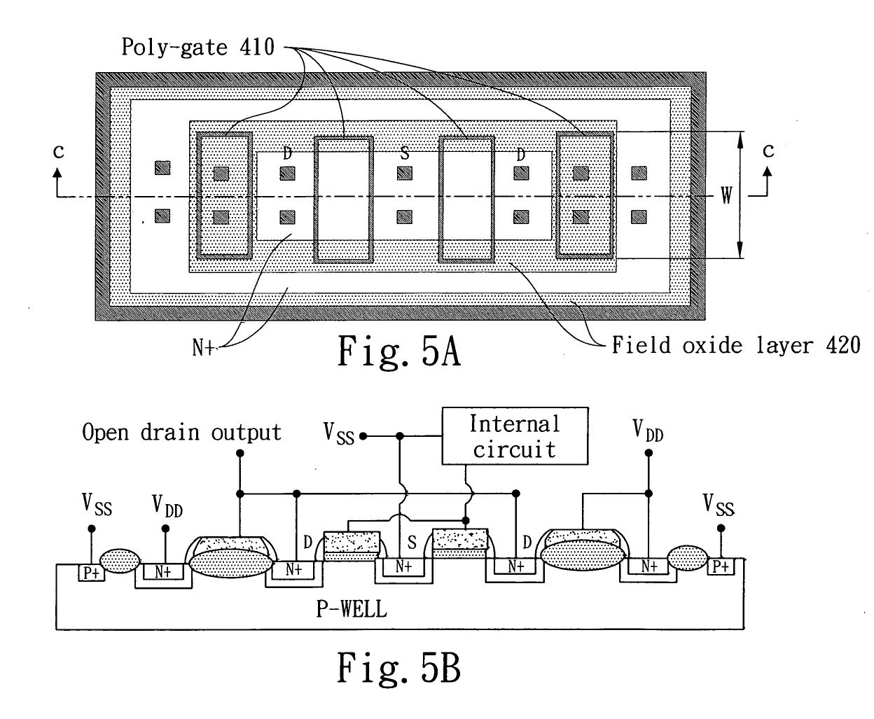

FIG. 5A is a layout structure for the two-directional ESD protection device. The cross-section structure along c-c line on FIG. 5A is shown on FIG. 5B. Increasing/decreasing the width (W) of poly-gate grown on field oxide layer according to the layout on FIG. 5A is also to increase/decrease the loading of ESD current in n channel below the poly gate in for fitting different requirements of ESD protection.

In an exemplary embodiment, a voltage range of normal operation is between V_{DD}−15V and V_{DD}+15V. A two-directional ESD protection device according to the invention can keep the internal circuit working normally event when the working voltage is negatively near V_{DD}+15V or positively near V_{DD}−15V, and shunt ESD current to against any abnormal discharge beyond the operation range.

Accordingly, as disclosed by the above description and accompanying drawings, the present invention surely can accomplish its objective to provide ESD protection method and device with known and adjustable trigger voltage, and may be put into industrial use especially for mass product.

It should be understood that various modifications and variations could be made from the teaching disclosed above by the person familiar in the art, without departing the spirit of the present invention.

What is claimed is:

1. An electrostatic discharge (ESD) protection method to protect an internal circuit against ESD effects and harms comprises the following steps:
(a) accept ESD current through a first ESD port P₁ while an ESD event happens on the internal circuit;
(b) discharge the ESD current from a second ESD port P₂ while an ESD event happens on the internal circuit; and, at the same time,
(c) utilize voltage differential between the first ESD port P₁ and the second ESD port P₂ to induce an inversion layer in depletion layer below gate field oxide layer of a 1^{st} NMOS and shunt the ESD current through the inversion n channel from the first ESD port P₁ to the second ESD port P₂ rapidly.

2. A one-directional electrostatic discharge (ESD) protection device to protect an internal circuit against ESD effects and harms in one direction comprises:
(a) a first ESD port P₁ with voltage V₁ for ESD current acceptance while an ESD event happens on the internal circuit;
(b) a second ESD port P₂ with voltage V₂ for ESD current discharge while an ESD event happens on the internal circuit; and
(c) a 1^{st} NMOS with its gate connected to the first ESD port P₁, its drain connected to the first ESD port P₁, and its source connected to the second ESD port P₂, wherein a short between its drain and source is formed to shunt ESD current without passing through the internal circuit while voltage differential between the first ESD port P₁ and the second ESD port P₂ is larger and equal than its gate threshold voltage Vₜₕ (V₁−V₂≧Vₜₕ).

3. A one-directional electrostatic discharge (ESD) protection device according to claim 2, wherein the voltage differential between the first ESD port P₁ and the second ESD port P₂ is smaller than gate threshold voltage Vₜₕ (V₁−V₂<Vₜₕ) and is small enough to not form a short between drain and source on the 1^{st} NMOS in normal operation.

4. A one-directional electrostatic discharge (ESD) protection device according to claim 2, wherein the 1^{st} NMOS is operable to be a field n-channel metal-oxide-semiconductor field effect transistor (field NMOS) with a field oxide layer below gate for increasing threshold voltage Vₜₕ.

5. A one-directional electrostatic discharge (ESD) protection device according to claim 4, wherein the threshold voltage Vₜₕ can be adjusted to fit different operation voltage condition (V₁−V₂<Vₜₕ) by choosing the filed NMOS from different semiconductor process.

6. A one-directional electrostatic discharge (ESD) protection device according to claim 4, wherein the 1^{st} NMOS with field NMOS having larger Vₜₕ can be used between I/O port with open drain output and power voltage V_{DD} directly as ESD protection.

7. A one-directional electrostatic discharge (ESD) protection device according to claim 2, wherein gate of the 1^{st} NMOS is operable to be poly-gate to provide the better ESD protection result.

8. A two-directional electrostatic discharge (ESD) protection device to protect an internal circuit against ESD effects and harms in both direction comprises:
(a) a first ESD port P₁ with voltage V₁ for ESD current acceptance/discharge while an ESD event happens on the internal circuit;
(b) a second ESD port P₂ with voltage V₂ for ESD current discharge/acceptance while an ESD event happens on the internal circuit;
(c) a 1^{st} NMOS with its gate connected to the first ESD port P₁, its drain connected to the first ESD port P₁, and its source connected to the second ESD port P₂, wherein a short between its drain and source is formed to shunt ESD current without passing through the internal circuit while voltage differential between the first ESD port P₁ and the second ESD port P₂ is larger and equal than its gate threshold voltage Vₜₕ (V₁−V₂≧Vₜₕ); and
(d) a 2^{nd} NMOS with its gate connected to the second ESD port P₂, its drain connected to the second ESD port P₂, and its source connected to the first ESD port P₁, wherein a short between its drain and source is formed to shunt ESD current without passing through the internal circuit while voltage differential between the second ESD port P₂ and the first ESD port P₁ is larger and equal than its gate threshold voltage Vₜₕ (V₂−V₁≧Vₜₕ).

9. A two-directional electrostatic discharge (ESD) protection device according to claim 8, wherein the absolute value of voltage differential between the first ESD port P₁ and the second ESD port P₂ is smaller than gate threshold voltage Vₜₕ (|V₁−V₂|<Vₜₕ) and is small enough to not form a short between drain and source on either of the 1^{st} NMOS and the 2^{nd} NMOS.

10. A two-directional electrostatic discharge (ESD) protection device according to claim 8, wherein the 1^{st} NMOS is operable to be a field n-channel metal-oxide-semiconductor field effect transistor (field NMOS) with a field oxide layer below gate for increasing threshold voltage Vₜₕ.

11. A two-directional electrostatic discharge (ESD) protection device according to claim 10, wherein threshold voltage Vₜₕ of the 1^{st} NMOS can be adjusted to fit different operation voltage condition (V₁−V₂<Vₜₕ) by choosing the filed NMOS from different semiconductor process.

12. A two-directional electrostatic discharge (ESD) protection device according to claim 8, wherein the 2^{nd} NMOS is operable to be a field n-channel metal-oxide-semiconductor field effect transistor (field NMOS) with a field oxide layer below gate for increasing threshold voltage Vₜₕ.

13. A two-directional electrostatic discharge (ESD) protection device according to claim 12, wherein threshold voltage Vₜₕ of the 2^{nd} NMOS can be adjusted to fit different operation voltage condition (V₂−V₁<Vₜₕ) by choosing the filed NMOS from different semiconductor process.

14. A two-directional electrostatic discharge (ESD) protection device according to claim 10, wherein the 1^{st} NMOS with field NMOS having larger Vₜₕ can be used between I/O port with open drain output and power voltage V_{DD} directly as ESD protection.

15. A two-directional electrostatic discharge (ESD) protection device according to claim 12, wherein the 2^{nd t} NMOS with field NMOS having larger Vₜₕ can be used as ESD protection to against ESD event from power voltage V_{DD}.

16. A two-directional electrostatic discharge (ESD) protection device according to claim 8, wherein gate of the 1^{st} NMOS is operable to be poly-gate to provide the better ESD protection result.

17. A two-directional electrostatic discharge (ESD) protection device according to claim 8, wherein gate of the 2^{nd} NMOS is operable to be poly-gate to provide the better ESD protection result.
